(19) United States
(12) Patent Application Publication
(10) Pub. No.: US 2019/0003249 A1
(43) Pub. Date: Jan. 3, 2019

(54) APPARATUS AND METHOD FOR DETECTING WEATHER STRIP SEAM

(71) Applicants: Hyundai Motor Company, Seoul (KR); Kia Motors Corporation, Seoul (KR)

(72) Inventors: Hyun Soo Lee, Seongnam (KR); Chanwoo Choi, Pyeongtaek (KR); Junhong Lim, Seoul (KR)

(21) Appl. No.: 15/793,610

(22) Filed: Oct. 25, 2017

(30) Foreign Application Priority Data
Jul. 3, 2017 (KR) 10-2017-0084442

(51) Int. Cl. E06B 7/098; B23P 19/04; B60J 10/00; B23P 19/10

(52) U.S. Cl. CPC E06B 7/098; B23P 19/047; B60R 13/06; B23P 19/105; B60J 10/45

(57) ABSTRACT

An apparatus for detecting a weather strip seam includes a sensing roller connected to one surface of a weather strip and rotating along with movement of the weather strip, a load cell unit sensing a signal corresponding to force transmitted to the sensing roller in the weather strip, and a controller that senses a seam formed in the weather strip using the signal sensed by the load cell unit.

### CROSS-REFERENCE TO RELATED APPLICATION

This application claims under 35 U.S.C. § 119(a) the benefit of Korean Patent Application No. 10-2017-0084442 filed in the Korean Intellectual Property Office on Jul. 3, 2017, the entire contents of which are incorporated herein by reference.

### BACKGROUND

### (a) Technical Field

The present disclosure relates to an apparatus and a method for detecting a seam in a weather strip attached to a door to stably perform a weather strip attaching process.

### (b) Description of the Related Art

A method of attaching a seal or weather strip to a vehicle door is known from German Publication 10138781, where the seal or weather strip has a continuous supply form in a supply roll and an adhesive surface of the weather strip is rolled and attached continuously along a periphery of the vehicle door.

The weather strip wrapped around the supply roll is pre-made in a production process, the adhesive surface on the weather strip is formed in the production process, and the outwardly facing adhesive surface is covered by a liner.

Therefore, in the weather strip production process, a process of extruding the weather strip and a process of attaching the adhesive layer are required, and the adhesion of the adhesive layer must be accurately performed together with the extrusion process.

On the other hand, in the process of extruding the weather strip, a process of cutting off an excess portion of the weather strip where the extrusion has already been completed and connecting the normal weather strip to each other is further performed, and seams may be formed in the weather strip made like this and wound on the supply roll.

Therefore, in the process of attaching the weather strip to a vehicle door, it is necessary to remove a seam section, attach the seamless section to the vehicle door, and provide a device and method for detecting the seam so that the seam is not attached to the vehicle door.

The above information disclosed in this Background section is only for enhancement of understanding of the background of the disclosure and therefore it may contain information that does not form the prior art that is already known in this country to a person of ordinary skill in the art.

### SUMMARY

The present disclosure provides an apparatus and a method for detecting a weather strip seam having advantages of effectively detecting a weather strip seam during attachment of a weather strip to a vehicle and automatically removing a weather strip seam section.

An apparatus for detecting a weather strip seam according to an exemplary embodiment of the present disclosure may include a sensing roller being connected to a one surface of a weather strip and rotating along with movement of the weather strip, a load cell unit sensing a signal corresponding to the force transmitted to the sensing roller in the weather strip, and a controller that senses a seam formed in the weather strip using the signal sensed by the load cell unit, in particular, where the seam is sensed using a variation characteristic of the signal sensed by the load cell unit.

The load cell unit may include a sensing roller disposed to contact one surface of the weather strip and a load cell sensing the force transmitted through the sensing roller.

A rod connected to a rotational axis of the sensing roller, a plate disposed at an end portion of the rod on the opposite side of the sensing roller, and an elastic member interposed between the load cell and the plate, may be further included.

A housing in which the load cell, the elastic member and the plate are mounted and from which the rod is extended outside, and a fixed bracket fixing the housing, may be further included.

A support roller disposed on the opposite side of the sensing roller in the weather strip to rotate along with movement of the weather strip and be fixed, may be further included.

A method for detecting a weather strip seam according to an exemplary embodiment of the present disclosure may include the steps of contacting one side of a weather strip and sensing a force transmitted to a sensing roller rotating according to movement of the weather strip, and sensing a seam formed in the weather strip using the sensed force.

A step of supporting an opposite surface of the weather strip using a support roller disposed on an opposite side of the sensing roller, may be further included.

A system for attaching a weather strip according to an exemplary embodiment of the present disclosure may include a supply part supplying a weather strip; an attachment head which attaches the weather strip supplied from the supply part to the surface of a part and cuts the weather strip at a predetermined position; an apparatus for detecting a weather strip seam including a sensing roller being connected to a one surface of a weather strip and rotating along with the movement of the weather strip, a load cell unit sensing a signal corresponding to the force transmitted to the sensing roller in the weather strip, and a controller that senses a seam formed in the weather strip using the signal sensed by the load cell unit and being disposed at a predetermined position between the supply part and attachment part including; and a controller calculating a first length of the weather strip required to complete the attachment of the weather strip to the part, calculating a second length of the weather strip existing between the position of the weather strip seam detected by apparatus for detecting a weather strip seam and a weather strip discharge side of the attachment head, and controlling the cutting position of the weather strip at the weather strip discharge side of the attachment head depending on the length relationship of the first length and the second length.

The second length of the weather strip may be preset.

The first length of the weather strip may be calculated by the length of the weather strip already attached to the part.

A robot which moves and rotates the part so that a surface of the part to which the weather strip is to be attached corresponds to the weather strip discharge side of the attachment head, may be further included.

When it is determined that the first length is longer than the second length, the controller discharges the section containing the seam to an outside without attaching the weather strip to part at the attachment head and cuts the weather strip.

A buffer part being disposed between the attachment head and the supply part and absorbing a difference between a supply length and a demand length of the weather strip, may be further included.

A method for attaching a weather strip according to an exemplary embodiment of the present disclosure may include the steps of supplying a weather strip, attaching the supplied weather strip to a surface of a part and cutting the weather strip at a predetermined position, detecting a weather strip seam at a predetermined position, calculating a first length of the weather strip required to complete the attachment of the weather strip to the part, calculating a second length of the weather strip existing between the position of the detected weather strip seam detected and a weather strip discharge side in which the weather strip is discharged to the surface of the part, and controlling the discharging and the cutting of the weather strip at the weather strip discharge side depending on the length relationship of the first length and the second length.

The second length of the weather strip may be preset, and the first length of the weather strip may be calculated by the length of the weather strip already attached to the part.

The step of moving and rotating the part so that the surface of the part to which the weather strip is to be attached corresponds to the weather strip discharge side of the attachment head, may be further included.

The step of discharging the section containing the weather strip seam to an outside and cutting the weather strip when it is determined that the first length is longer than the second length, may be further included.

The step of absorbing the difference between the supply length and the demand length of the weather strip, may be further included.

According to exemplary embodiments of the present disclosure, it is possible to effectively detect the seam section of the weather strip by using rollers and load cells.

Further, since the seam is detected by the mechanical method using the load cells, the degree of synergy is increased and it is not necessary to separately mark the portion where the weather strip seam is formed.

Further, it is possible to improve the quality and reliability of a vehicle by stably attaching a seamless weather strip to a vehicle door by stably removing the weather strip seam.

### BRIEF DESCRIPTION OF THE DRAWINGS

FIG. 1 is a schematic diagram of a weather strip attachment system according to an exemplary embodiment of the present disclosure.

FIG. 2 is a schematic cross-sectional view of an apparatus for detecting a weather strip seam according to an exemplary embodiment of the present disclosure.

FIG. 3 is a graph of the force sensed at a load cell unit according to an exemplary embodiment of the present disclosure.

FIG. 4 is a flowchart of a method for detecting a weather strip seam according to an exemplary embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, an exemplary embodiment of the present disclosure will be described in detail with reference to accompanying drawings.

However, since the size and thickness of each element shown in the drawing are arbitrarily shown for convenience of explanation, the present disclosure is not necessarily limited to that shown in the drawing, and the thickness is enlarged to clearly represent the various parts and regions.

In order to clearly illustrate an exemplary embodiment of the present disclosure, the parts not related to the description are omitted, and the same reference element is assigned to the same or similar constituent elements throughout the specification.

In the following description, to distinguish the names of the elements into first, second, and the like is to distinguish these because the names of the elements are the same, and it is not necessarily limited to the order.

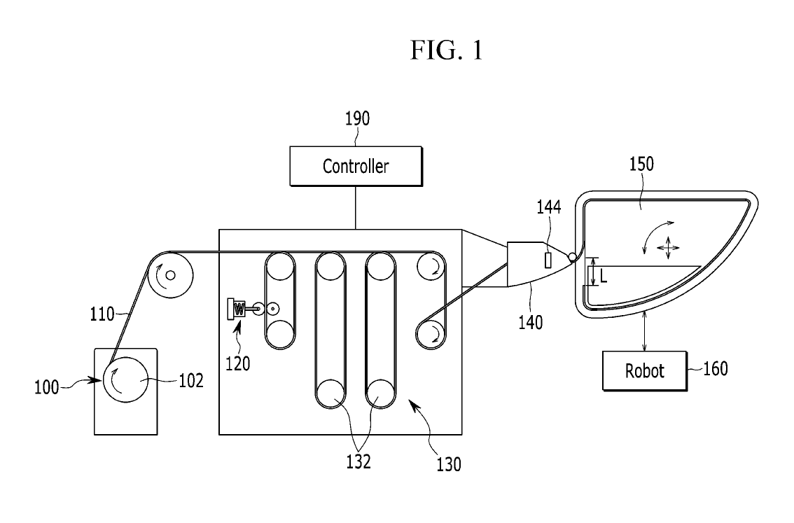

FIG. 1 is a schematic diagram of a weather strip attachment system according to an exemplary embodiment of the present disclosure.

Referring to FIG. 1, a weather strip attaching system may include a supply part 100 containing a supply roller 102, a weather strip 110, a buffer part 130 containing a buffer roller 132, an attachment head 140 containing a cutting part 144, a door 150, a robot 160 and a controller 190. A load cell unit 120 detecting a seam of the weather strip 110 may be disposed at one side of the buffer part 130.

The weather strip 110 may be wound on the supply roller 102. The supply roller 102 continuously supplies the weather strip 110 to the attachment head 140.

The buffer part 130 may be disposed between the supply roller 102 and the attachment head 140 to provide tension to the weather strip 110.

The robot 160 rotates or moves the door 150 relative to the discharge port of the weather strip 110 of the attachment head 140, so that the weather strip 110 discharged along the discharge port of the attachment head 140 is continuously attached along the circumference of the door 150.

In addition, the attachment head 140 may be provided with a cutting portion 144 for cutting the weather strip 110 attached along the circumference of the door 150.

In the door 150, there is a first length (L) to which the weather strip 110 is not attached, and the controller 190 may calculate the first length (L) to which the weather strip 110 is not attached in real time.

The load cell unit 120 senses the seam 200 of the weather strip 110 being continuously supplied, and the controller 190 can calculate a second length of the weather strip 110 between the seam 200 and the attachment head 140 in real time.

In this regard, the second length may be a predetermined value or may be calculated in the controller 190 as a value varying in real time.

The controller 190 may be implemented with at least one microprocessor operating according to a predetermined program, and the predetermined program may include a series of instructions for performing a method according to an exemplary embodiment of the present disclosure.

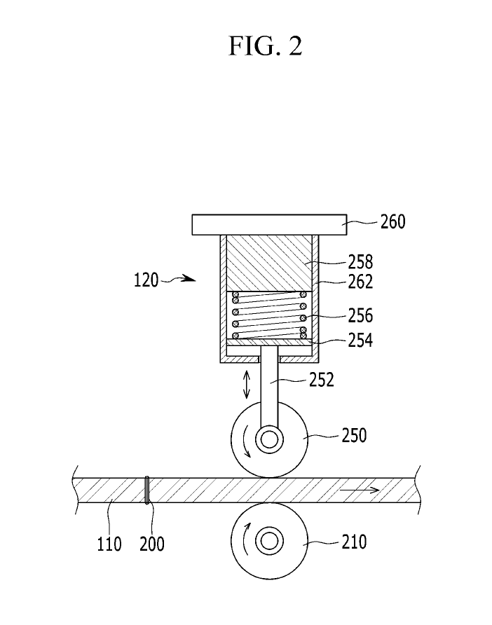

FIG. 2 is a schematic cross-sectional view of an apparatus for detecting a weather strip seam according to an exemplary embodiment of the present disclosure.

Referring to FIG. 2, the load cell unit 120 may include a support roller 210, a sensing roller 250, a rod 252, a plate 254, an elastic member 256, a load cell 258, a housing 262, and a fixed bracket 260.

The weather strip 110 may move along a predetermined route. The sensing roller 250 may be disposed on one side of the weather strip 110, the support roller 210 may be disposed on the other side of the weather strip 110 at a position corresponding to the sensing roller 250, and when the weather strip 110 moves, the support roller 210 and the sensing roller 250 rotate respectively.

One end of the rod 252 may be connected to the rotation axis of the sensing roller 250, and the plate 254 is fixed to the other end of the rod.

The load cell 258 may be disposed at a predetermined distance from the plate 254, and an elastic member may be interposed between the load cell 258 and the plate 254.

The plate 254, the elastic member 256 and the load cell 258 may be installed in the housing 262, and the rod 252 is connected to the rotation axis of the sensing roller 250 through the center of the tip of the housing 262, and the other end of the housing 262 is closed by the fixed bracket 260.

The fixed bracket 260 may be fixed to a fixing member such as a frame.

The elastic member 256 presses the sensing roller 250 through the rod 252 with a predetermined force on one surface of the weather strip 110.

The support roll 210 supports the other surface of the weather strip 110.

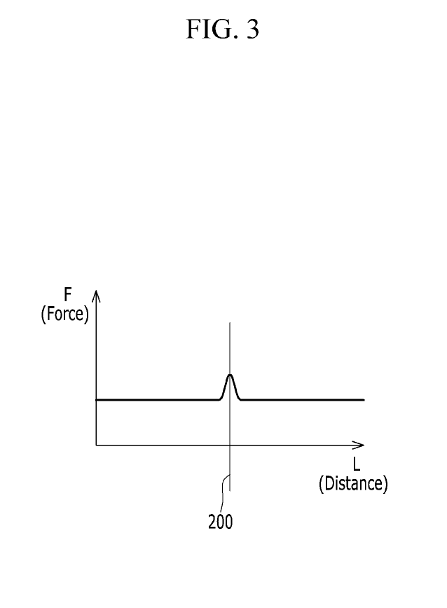

FIG. 3 is a graph of the force sensed at a load cell unit according to an exemplary embodiment of the present disclosure.

Referring to FIG. 3, a horizontal axis represents the travel distance of the weather strip 110, and a vertical axis represents the force sensed by the load cell 258.

In response to the position where the seam 200 is formed, the force sensed by the load cell 258 temporarily rises.

In the exemplary embodiment of the present disclosure, the controller 190 can detect a temporary increase in the force sensed at the load cell 258 and select or calculate the second length of the weather strip 110 disposed between the attachment head 140 and the load cell unit 120.

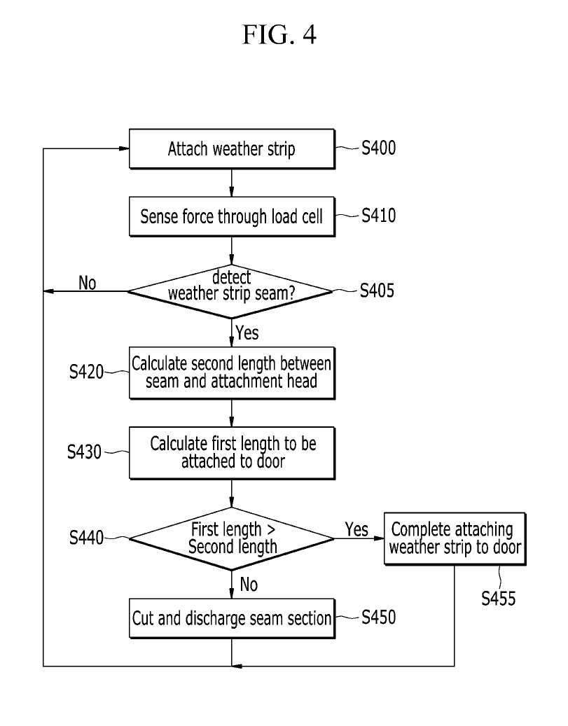

FIG. 4 is a flowchart of a method for detecting a weather strip seam according to an exemplary embodiment of the present disclosure.

Referring to FIG. 4, it begins to attach the weather strip 110 to the door 150 at step S400.

The load cell 258 senses the force transmitted through the load 252 at step S410.

The controller 190 uses the force sensed by the load cell 258 to determine whether the seam 200 exists at step S405.

In particular, if the seam 200 does not exist, step S400 is performed, and if the seam 200 exists, step S420 is performed.

The second length between the sensed seam 200 and the attachment head 140 is calculated or selected at step S420.

The second length may be the length of the weather strip 110 between the load cell unit 120 and the attachment head 140, and may have a predetermined value.

The first length of the weather strip 110 to be attached to the door is calculated at step S430. The first length may correspond to “L” shown in FIG. 1. The first length may change to real time, and may vary according to the specification of the door.

In step S440, a length relation between the first and second lengths is calculated, and if it is determined that the first length is smaller than the second length, then step S450 is performed, if not, then step S455 is performed.

In step S450, the attachment head 140 cuts out an interval in which the seam 200 sensed by the load cell unit 120 exists, and then the process is returned to step S400 to attach the weather strip 110 to the door 150 continuously.

Then, in step S455, the attachment of the weather strip 110 to the door 150 is completed, and thereafter, the process is returned to step S400.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. An apparatus for detecting a weather strip seam, the apparatus comprising:
a sensing roller connected to one surface of a weather strip and rotating along with movement of the weather strip;
a load cell unit sensing a signal corresponding to force transmitted to the sensing roller in the weather strip; and
a controller that senses a seam formed in the weather strip using the signal sensed by the load cell unit.

2. The apparatus of claim 1, wherein the load cell unit comprises:
a sensing roller disposed to contact one surface of the weather strip; and
a load cell sensing the force transmitted through the sensing roller.

3. The apparatus of claim 2, further comprising:
a rod connected to a rotational axis of the sensing roller;
a plate disposed at an end portion of the rod on an opposite side of the sensing roller; and
an elastic member interposed between the load cell and the plate;

4. The apparatus of claim 3, further comprising:
a housing in which the load cell, the elastic member, and the plate are mounted, and from which the rod is extended outside; and
a fixed bracket fixing the housing.

5. The apparatus of claim 3, further comprising:
a support roller disposed on the opposite side of the sensing roller in the weather strip to rotate along with the movement of the weather strip and be fixed.

6. A method for detecting a weather strip seam, comprising the steps of:
contacting one side of a weather strip and sensing a force transmitted to a sensing roller rotating according to movement of the weather strip; and
sensing a seam formed in the weather strip using the sensed force.

7. The method of claim 6, further comprising:
supporting an opposite surface of the weather strip using a support roller disposed on an opposite side of the sensing roller.

8. A system for attaching a weather strip, comprising:
a supply part supplying a weather strip;
an attachment head which attaches the weather strip supplied from the supply part to a surface of a part and cuts the weather strip at a predetermined position;
the apparatus for detecting the weather strip seam of claim 1 disposed at a predetermined position between the supply part and attachment part; and
a controller calculating a first length of the weather strip required to complete the attachment of the weather strip to the part, calculating a second length of the weather strip existing between the position of the weather strip seam detected by the apparatus for detecting the weather strip seam and a weather strip discharge side of the attachment head, and controlling the cutting position of the weather strip at the weather strip discharge side of the attachment head depending on a length relationship of the first length and the second length.

9. The system of claim 8, wherein:
the second length of the weather strip is preset.

10. The system of claim 8, wherein:
the first length of the weather strip is calculated by a length of the weather strip already attached to the part.

11. The system of claim 8, further comprising:
a robot which moves and rotates the part so that the surface of the part to which the weather strip is to be attached corresponds to the weather strip discharge side of the attachment head.

12. The system of claim 8, wherein:
when it is determined that the first length is smaller than the second length, the controller discharges the section containing the seam to an outside without attaching the weather strip to part at the attachment head and cuts the weather strip.

13. The system of claim 8, further comprising:
a buffer part disposed between the attachment head and the supply part and absorbing the difference between a supply length and a demand length of the weather strip.

14. A method for attaching a weather strip, comprising the steps of:
supplying a weather strip;
attaching the supplied weather strip to a surface of a part and cutting the weather strip at a predetermined position;
detecting a weather strip seam at a predetermined position;
calculating a first length of the weather strip required to complete the attachment of the weather strip to the part;
calculating a second length of the weather strip existing between the position of the detected weather strip seam detected and a weather strip discharge side in which the weather strip is discharged to the surface of the part; and
controlling the discharging and the cutting of the weather strip at the weather strip discharge side depending on the length relationship of the first length and the second length

15. The method of claim 14, wherein:
the second length of the weather strip is preset, and the first length of the weather strip is calculated by the length of the weather strip already attached to the par.

16. The method of claim 14, further comprising the step of:
moving and rotating the part so that the surface of the part to which the weather strip is to be attached corresponds to the weather strip discharge side of the attachment head.

17. The method of claim 14, further comprising the step of:
discharging the section containing the weather strip seam to an outside and cutting the weather strip when it is determined that the first length is smaller than the second length.

18. The method of claim 14, further comprising the step of:
absorbing a difference between a supply length and a demand length of the weather strip.
